(19) United States
(12) Patent Application Publication
(10) Pub. No.: US 2025/0348279 A1
(43) Pub. Date: Nov. 13, 2025

(54) SYSTEMS AND METHODS FOR PERFORMING MAC OPERATIONS ON FLOATING POINT NUMBERS

(71) Applicant: Taiwan Semiconductor Manufacturing Company, Ltd., Hsinchu (TW)

(72) Inventors: Chia-Fu Lee, Hsinchu (TW); Yu-Der Chih, Hsinchu (TW); Jonathan Tsung-Yung Chang, Hsinchu (TW)

(73) Assignee: Taiwan Semiconductor Manufacturing Company, Ltd., Hsinchu (TW)

(21) Appl. No.: 19/279,316

(22) Filed: Jul. 24, 2025

Related U.S. Application Data
(63) Continuation of application No. 18/469,879, filed on Sep. 19, 2023.
(60) Provisional application No. 63/502,552, filed on May 16, 2023.

(51) Int. Cl. G06F 7/544; G06F 7/483

(52) U.S. Cl. CPC G06F 7/5443; G06F 7/483

(57) ABSTRACT

A computing-in-memory circuit includes an input circuit to receive a number (N) of input pairs, each of the N input pairs comprising a first one and a second one of N exponents, and a first one and a second one of N mantissas; a first adder circuit to generate N exponent sums based on the first and second exponents of the N input pairs; a subtractor circuit configured to calculate N exponent differences, each of the N exponent differences being equal to a difference between a corresponding one of the N exponent sums and a largest one of the N exponent sums; and a comparator circuit to compare each of the N exponent differences with a threshold to generate N control signals. N mantissa products of the first and second mantissas of the N input pairs, respectively, are to be selectively combined based on the N control signals.

### CROSS-REFERENCE TO RELATED APPLICATION

This application is a continuation of U.S. patent application Ser. No. 18/469,879, filed Sep. 19, 2023, which claims priority to and the benefit of U.S. Provisional Application No. 63/502,552, filed May 16, 2023, which is incorporated herein by reference in its entirety for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data computation circuit for performing MAC operations on floating point numbers, in accordance with some embodiments.

FIG. 2 is an example flow chart of a method for operating the data computation circuit of FIG. 1, in accordance with some embodiments.

FIG. 3 is a schematic diagram of an implementation of the data computation circuit of FIG. 1, in accordance with some embodiments.

FIG. 4 is a block diagram of another data computation circuit for performing MAC operations on floating point numbers, in accordance with some embodiments.

FIG. 5 is an example flow chart of a method for operating the data computation circuit of FIG. 4, in accordance with some embodiments.

FIGS. 6 and 7 are each a schematic diagram of an implementation of the data computation circuit of FIG. 4, in accordance with some embodiments.

FIG. 8 is a schematic diagram of a comparator of the data computation circuit of FIGS. 1 and 4, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, computing-in-memory (CIM) circuits have been proposed to perform such MAC operations. Similar to a human brain, a CIM circuit instead conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

The data elements, processed by the CIM circuit, have various types or forms, such as integers number and floating point numbers. A floating point number is typically represented by a sign portion, an exponent portion, and a significand (mantissa) portion that consists of the significant digits of the number. For example, a floating point number format specified by the Institute of Electrical and Electronics Engineers (IEEE®) is thirty-two bits in size and includes twenty-three mantissa bits, eight exponent bits, and one sign bit. Another floating point number format is sixteen bits in size, which includes ten mantissa bits, five exponent bits, and one sign bit.

In machine learning applications, the CIM circuit is frequently configured to process dot product multiplications based on performing MAC operations on a large number of data elements (e.g., an input word vector and a weight matrix), which may each be in the form of floating point numbers, and then process addition (or accumulation) of such dot products. Multiplication of each floating point number pair, generally, includes addition of respective exponent portions (generating an exponent sum) and multiplication of respective mantissa portions (generating a mantissa product). Further, the exponent sum of each floating point number pair is compared to a maximum exponent sum among the plural floating point number pairs to generate an exponent difference. Such exponent differences are utilized to align the exponent portions of the different floating point number pairs, so as to shift the corresponding mantissa products. The shifted mantissa products are summed, with an exponent of the maximum exponent sum, to reach the final sum.

With such an approach, accuracy of the final sum is typically compromised. For example, when accumulating the numbers with widely different exponent differences together, the number pair having a relatively small exponent difference, which corresponds to a large value of dot product, may cause the number pair having a relatively normal exponent difference, which corresponds to a medium value of dot product, to be truncated. This is because the mantissa product with those normal exponent differences is shifted according to the maximum exponent difference. While the dot product with the small exponent difference is not affected, a certain portion of the dot product with the normal exponent difference is truncated. Further, the small exponent difference (large dot product) is generally associated with a significantly small distribution percentage, when compared to the large distribution percentage of the normal exponent difference (medium dot product). With these widely different exponent differences being processed together, error accumulated within the medium dot products can be enlarged to disadvantageously impact accuracy of the final sum. Thus, the existing CIM circuits (e.g., configured to perform MAC operations on floating point numbers) have not been entirely satisfactory in some aspects.

The present disclosure provides various embodiments of a compute-in-memory (CIM) circuit that can separately process respective mantissa products of a large number of floating point number pairs based on their distribution percentages. In one aspect of the present disclosure, the disclosed CIM circuit may include a dedicated circuit to handle the sum of mantissa products associated with exponent differences being equal to or less than a difference threshold, in parallel with handling the sum of mantissa products associated with exponent differences being greater than the difference threshold. In another aspect of the present disclosure, the disclosed CIM circuit can handle the sum of mantissa products associated with exponent differences being greater than a difference threshold during a first time period, and handle the sum of mantissa products associated with exponent differences being equal to or less than the difference threshold during a second time period. Such a difference threshold can be dynamically configured based on the distribution percentages of these “normal” and “small” exponent differences, that are greater than and equal to or less than the difference threshold, respectively. For example, the CIM circuit can determine a difference threshold by identifying that some of the exponent differences, while being less than or equal to the difference threshold, occupy a relatively low percentage of all the exponent differences, and that most of the exponent differences are greater than the difference threshold. By separating processing the mantissa products with different exponent differences, the mantissa products with the normal exponent differences may be immune from being contaminated (e.g., truncated) by the mantissa products with the small exponent differences, which can advantageously improve the accuracy of a final sum on multiplications of the floating point number pairs.

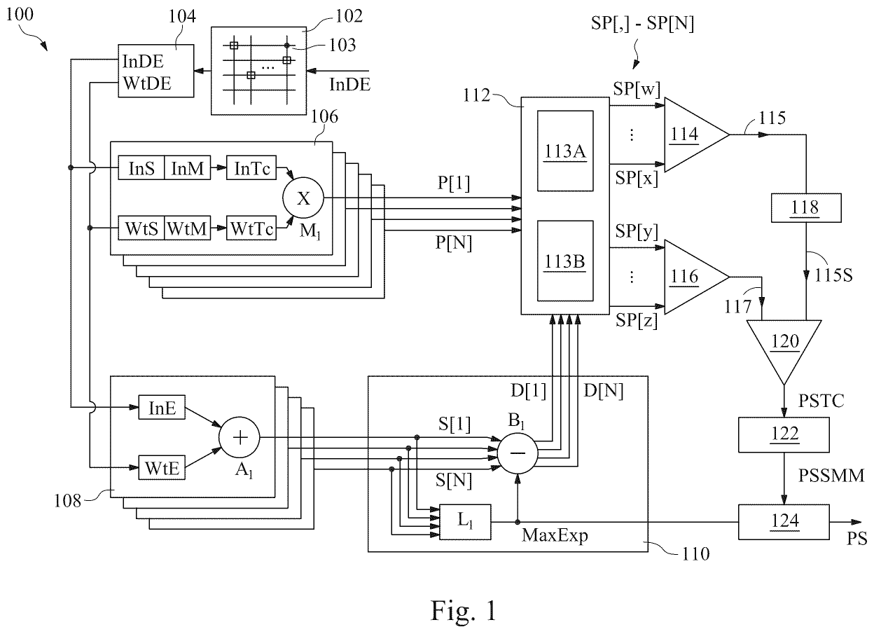

FIG. 1 illustrates a block diagram of a data computation circuit 100, in accordance with some embodiments of the present disclosure. In the illustrated embodiment depicted in FIG. 1, the data computation circuit 100, also referred to as circuit 100 or memory circuit 100, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (N) of weight data elements WtDE. In various embodiments, each of the input data elements InDE and the weight data elements WtDE may include a floating point number.

As shown, the circuit 100 includes a memory circuit 102, an input circuit 104, a number of multiplier circuits 106, a number of summing circuits 108, a difference circuit 110, a first shifting circuit 112, a first adder circuit (or adder tree) 114, a second adder circuit (or adder tree) 116, a second shifting circuit 118, a third adder circuit (or adder tree) 120, a first converter 122, and a second converter 124. In some embodiments, the number of multiplier circuits 106 may correspond to the number of summing circuits 108. For example, the circuit 100 may include N (the number of weight/input data elements WtDE/InDE) multiplier circuits 106 and N (the number of weight/input data elements WtDE/InDE) summing circuits 108. It should be appreciated that the block diagram of the circuit depicted in FIG. 1 is simplified, and thus, the circuit 100 can include any of various other components while remaining within the scope of the present disclosure.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, an SRAM cell includes a multi-track SRAM cell. In some embodiments, an SRAM cell includes a length at least two times greater than a width.

In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 so as to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements WtDE. In some embodiments, the programming circuits may write the weight data elements WtDE into corresponding storage elements 103 of the memory arrays, respectively, while the reading circuit may read bits written into the storage elements 103, so as to verify or otherwise test whether the written weight data elements WtDE are correct. The drivers of the memory circuit 102 can include or be operatively coupled to a number of input activation latches that are configured to receive and temporarily store the input data elements InDE. In some other embodiments, such input activation latches may be part of the input circuit 104, which can further include a number of buffers that are configured to temporarily store the weight data elements WtDE retrieved from the memory arrays of the memory circuit 102. As such, the input circuit 104 can receive the input data elements InDE and the weight data elements WtDE.

In various embodiments of the present disclosure, the input word vector (including, e.g., the input data elements InDE) and the weight matrix (including, e.g., the weight data elements WtDE), on which the circuit 100 is configured to perform MAC operations, each include a number of floating point numbers. As such, each of the data elements InDE and weight data elements WtDE includes a sign bit, a plural number of exponent bits, and a plural number of mantissa bits (sometimes referred to as fraction bits).

For example, each of the data elements InDE and weight data elements WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

In some embodiments, each of the data elements InDE and the weight data elements WtDE has a FP16 format, also referred to as a half precision format, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one. In some other embodiments, each of the data elements InDE and the weight data elements WtDE has a floating-point format other than a BF16 or FP16 format, e.g., another 16-bit format, a 32-bit, 64-bit, 128-bit, or 256-bit format, or a 40-bit or 80-bit extended precision format. The sign and mantissa of a data element representing a floating-point number are collectively referred to as a signed mantissa of the floating-point number. The MSB of a mantissa is referred to as a hidden bit or hidden MSB.

Referring still to FIG. 1, the input circuit 104 is configured to output entireties of each data element of data elements InDE and WtDE to each of the multiplier circuits 106 and the summing circuits 108. In some embodiments, the input circuit 104 is configured to output the signed mantissa of each data element to the multiplier circuit 106 and the exponent of each data element to the summing circuit 108, which will be described as follows.

The multiplier circuits 106 are each an electronic circuit, e.g., an integrated circuit (IC), configured to receive, e.g., from the input circuit 104, a sign bit InS and a mantissa InM (collectively a signed mantissa InS/InM) of each of the N data elements InDE, and a sign bit WtS and a mantissa WtM (collectively a signed mantissa WtS/WtM) of each of the N data elements WtDE. The summing circuits 108 are each an electronic circuit, e.g., an IC, configured to receive, e.g., from the input circuit 104, an exponent InE of each of the N data elements InDE, and an exponent WtE of each of the N data elements WtDE.

The multiplier circuits 106 may each include one or more data registers (not shown) configured to receive the instances of signed mantissas InS/InM and WtS/WtM. In the embodiment depicted in FIG. 1, the multiplier circuit 106 is configured to receive the instances of signed mantissas InS/InM and WtS/WtM corresponding to data elements InDE and WtDE. In some other embodiments, the multiplier circuit 106 includes the one or more data registers configured to receive the instances of signed mantissas InS/InM and/or WtS/WtM including the hidden MSBs. In some embodiments, the multiplier circuit 106 includes the one or more data registers configured to add the hidden MSBs to the received instances of signed mantissas InS/InM and/or WtS/WtM.

The multiplier circuit 106 may further include logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WtTC. Reformatted mantissa InTC has a same number of bits as signed mantissa InS/InM, and reformatted mantissa WtTC has a same number of bits as signed mantissa WtS/WtM.

The multiplier circuit 106 may further include one or more logic gates M1 configured to, in operation, multiply some or all of the instances of reformatted mantissas InTC with some or all of the instances of reformatted mantissas WtTC, thereby generating N products, e.g., P[1] to P[N]. In various embodiments, the one or more logic gates M1 include one or more AND or NOR gates or other circuits suitable for performing some or all of a multiplication operation. The one or more logic gates M1 are configured to, in operation, generate each of the products P[1] to P[N] as a two's complement data element including a number of bits equal to twice the number of bits of reformatted mantissas InTC and WtTC minus one.

The multiplier circuits 106 are configured to, in operation, generate the number N of products P[1] to P[N]. For example, the multiplier circuits 106 can generate the number N of products P[1]-P[N] equal to sixteen. In some other embodiments, the multiplier circuits 106 can generate the number N of products P[1]-P[N] fewer or greater than sixteen.

In some embodiments, e.g., those in which data elements InDE and WtDE have the BF16 format, the multiplier circuit 106 is configured to generate each of the products P[1]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, the multiplier circuit 106 is configured to generate each of products P[1]-P[N] having a total of 23 bits based on each of signed mantissas InS/InM and WtS/WtM and reformatted mantissas InTC and WtTC having a total of 12 bits. Embodiments in which the multiplier circuit 106 is configured to generate each of products P[1]-P[N] having other total bit numbers based on each of signed mantissas InS/InM and WtS/WtM and reformatted mantissas InTC and WtTC having other total bit numbers are within the scope of the present disclosure.

The multiplier circuit 106 is thereby configured to, in operation, perform multiplication and reformatting operations on sign and mantissa bits of input data elements InDE and weight data elements WtDE so as to generate two's complement products P[1]-P[N]. The multiplier circuit 106 is configured to output products P[1]-P[N] to the shifting circuit 112 on a data bus (not shown).

The summing circuits 108 each include one or more data registers (not shown) configured to receive the instances of exponents InE and WtE corresponding to the number of data elements of data elements InDE and WtDE discussed above with respect to the multiplier circuit 106.

The summing circuits 108 each include one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The respective logic gates A1 of the summing circuits 108 are configured to generate exponent sums S[1]-S[N] as data elements having a total number of bits equal to the number of bits of each of exponents InE and WtE plus one.

The summing circuits 108 are configured to, in operation, generate the exponent sums S[1]-S[N] having the total number N and an ordering of data elements corresponding to the total number N and ordering of the data elements of the products P[1]-P[N] discussed above with respect to the multiplier circuit 106. Accordingly, for a total of N combinations of data elements InDE and WtDE, each n^{th} combination corresponds to both the n^{th} exponent sum S[n] of the exponent sums S[1]-S[N] and the n^{th} product P[n] of the products P[1]-P[N].

In some embodiments, e.g., those in which the data elements InDE and WtDE have the BF16 format, the summing circuit 108 is configured to generate each corresponding one of the exponent sums S[1]-S[N] having a total of nine bits based on each of the exponents InE and WtE having a total of eight bits. In some embodiments, e.g., those in which the data elements InDE and WtDE have the FP16 format, the summing circuit 108 is configured to generate each of the sums S[0]-S[N] having a total of six bits based on each of exponents InE and WtE having a total of five bits. The summing circuit 108 being configured to generate each of the exponent sums S[1]-S[N] having other total bit numbers based on each of exponents InE and WtE having other total bit numbers is within the scope of the present disclosure. The summing circuits 108 are configured to output the exponent sums S[1]-S[N] to the difference circuit 110 on a data bus (not shown).

The difference circuit 110 is an electronic circuit, e.g., an IC, including one or more logic gates L1 and one or more logic gates B1, each configured to receive the exponent sums S[1]-S[N] from the summing circuits 108. The one or more logic gates L1 may sometimes referred to as a selector, and the one or more logic gates B1 may sometimes be referred to as a subtractor. The one or more logic gates L1 are configured to, in operation, generate a maximum exponent sum MaxExp as a data element having a value equal to a maximum value of the data elements of the exponent sums S[1]-S[N] and having a number of bits equal to those of the data elements of the exponent sums S[1]-S[N]. The one or more logic gates L1 are configured to output maximum exponent sum MaxExp to the one or more logic gates B1 and to the converter circuit 124, as discussed below.

The one or more logic gates B1 are configured to, in operation, generate differences D[1]-D[N] by subtracting each data element of the exponent sums S[1]-S[N] from maximum exponent sum MaxExp. The differences D[1]-D[N] thereby have the total number N and ordering of data elements corresponding to that of the exponent sums S[1]-S[N] and the products P[1]-P[N] discussed above. In the embodiment depicted in FIG. 1, the one or more logic gates B1 are configured to output differences D[1]-D[N] to the shifting circuit 112 on a data bus (not shown). In some embodiments, the one or more logic gates B1 are not configured to output the differences D[1]-D[N] to the multiplier circuits 106, and the multiplier circuits 106 are each configured to generate each instance P[n] of products P[1]-P[N] by always performing the multiplying operation. In some other embodiments, the one or more logic gates B1 are configured to output the differences D[1]-D[N] to the multiplier circuits 106, respectively, and the multiplier circuits 106 are each configured to generate each instance P[n] of products P[1]-P[N] by selectively performing the multiplying operation based on a corresponding instance D[n].

The shifting circuit 112 is an electronic circuit, e.g., an IC, including one or more registers and/or logic gates configured to perform a shifting operation on each instance P[n] of the products P[1]-P[N] based on the value of the corresponding instance D[n] of the differences D[1]-D[N].

Each instance P[n] of the products P[1]-P[N] is based on the sign and mantissa of a corresponding combination of data elements InDE and WtDE, and each instance D[n] of the differences D[1]-D[N] is based on the sum of the exponents of the same combination. The shifting circuit 112 is configured to, in operation, right-shift each instance P[n] of the products P[1]-P[N] by an amount equal to the corresponding difference D[n], thereby generating shifted products SP[1]-SP[N] in which sign and mantissa bits are aligned in accordance with the summed exponents used to generate the differences D[1]-D[N]. Based on this alignment, the shifting circuit 112 is configured to generate each instance SP[n] of the shifted products SP[1]-SP[N] having a same exponent using the maximum exponent sum MaxExp as a baseline.

To compensate for the right-shifting operation, the shifting circuit 112 can add instances of the sign bit (zero or one) of each product P[n] as the leftmost bits of the corresponding shifted product SP[n]. The number of added instances of the sign bit is equal to the amount of the right shift as determined by the corresponding difference D[n].

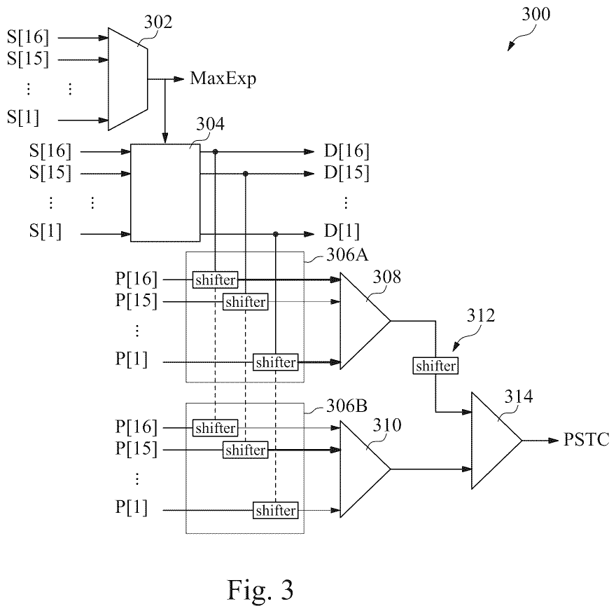

In the illustrated embodiment of FIG. 1, the multiplier circuit 106 can generate the corresponding instance P[n] of the products P[1]-P[N] by performing the multiplying operation, as discussed above. The shifting circuit 112 can include a number (e.g., N) of first shifters 113A and a number (e.g., N) of second shifters 113B (which will be descried with respect to FIG. 3). The first shifters 113A can receive the products P[1]-P[N] from the multiplier circuits 106, and selectively output (e.g., shift) one or more first ones of the shifted products SP[1]-SP[N] to the adder circuit 114 based on the respective differences D[1]-D[N]; and the second shifter circuits 113B can receive the products P[1]-P[N] from the multiplier circuits 106, and selectively output (e.g., shift) one or more second ones of the shifted products SP[1]-SP[N] to the adder circuit 116 based on the respective differences D[1]-D[N]. For example in FIG. 1, the first shifted products outputted to the adder circuit 114 may include SP[w]-SP[x], and the second shifted products outputted to the adder circuit 116 may include SP[y]-SP[z], where “w,” “x,” “y,” and “z” may each be one of the integers from 1 to N. In one aspect of the present disclosure, a sum of the number of SP[w]-SP[x] and the number of SP[y]-SP[z] may be equal to N. In another aspect of the present disclosure, a sum of the number of SP[w]-SP[x] and the number of SP[y]-SP[z] may be less than N.

The shifters 113A and 113B can be controlled (e.g., selectively activated) by a number (e.g., N) of control signals generated based on comparing corresponding ones of the differences D[1]-D[N] with a first difference threshold (not shown in FIG. 1). The first difference threshold can be configured based on a distribution of the differences D[1]-D[N]. In an example where the differences D[1]-D[N] are presented as a normal distribution, the first difference threshold may be determined at one standard deviation below a mean of the normal distribution. In another example where the differences D[1]-D[N] are still presented as a normal distribution, the first difference threshold may be determined at two standard deviations below a mean of the normal distribution. In yet another example where the differences D[1]-D[N] are still presented as a normal distribution, the first difference threshold may be determined at any value of standard deviations below a mean of the normal distribution.

When any of the difference, e.g., D[n] where n is an integer between 1 to N, is equal to or less than the first difference threshold (sometimes referred to as a “small exponent difference”), a corresponding one of the first shifters 113A is deactivated to block the corresponding shifted product SP[n] from being received by the adder circuit 114 (e.g., not shifting the corresponding product P[n] or being decoupled from the adder circuit 114), and a corresponding one of the second shifters is activated to output the corresponding shifted product SP[n] to the adder circuit 116 (i.e., shifting the corresponding product P[n] and outputting it to the adder circuit 116). Equivalently, when any of the difference, e.g., D[n], is greater than the first difference threshold (sometimes referred to as a “normal exponent difference”), a corresponding one of the first shifters 113A is activated to output the corresponding shifted product SP[n] to the adder circuit 114, and a corresponding one of the second shifters is deactivated to block the corresponding shifted product SP[n] from being received by the adder circuit 116.

In other words, the shifting circuit 112 can shift all of the products P[1]-P[N], and selectively output the shifted products SP[1]-SP[N] to either the adder circuit 114 or the adder circuit 116 based on comparing the respective differences D[1]-D[N] with the first difference threshold. As such, a sum of the number of SP[w]-SP[x] (outputted by the first shifters 113A) and the number of SP[y]-SP[z] (outputted by the second shifters 113B) may be equal to N. In various embodiments, the first shifters 113A and the second shifters 113B may output their shifted products to the adder circuit 114 and the adder circuit 116, respectively, in parallel. That is, the adder circuit 114 can receive the shifted products SP[w]-SP[x] and the adder circuit 116 can receive the shifted products SP[y]-SP[z] in parallel.

Further, to generate the SP[w]-SP[x], the first shifters 113A may right-shift each instance P[n] of the products P[w]-P[x] by an amount equal to a corresponding difference DA [n], thereby aligning sign and mantissa bits in accordance with the summed exponents. In some embodiments, the difference DA [n] may be generated (e.g., by the difference circuit 110) based on subtracting each data element of sums S[w]-S[x] from a “local” maximum exponent sum MaxExpA. The local maximum exponent sum MaxExpA may correspond to a maximum value of the data elements of the sums S[w]-S[x]. Based on this alignment, the first shifters 113A can generate each instance SP[n] of the shifted products SP[w]-SP[x] having a same exponent using the maximum exponent sum MaxExpA as a baseline. Similarly, the second shifters 113B may right-shift each instance P[n] of the products P[y]-P[z] by an amount equal to a corresponding difference DB [n], thereby aligning sign and mantissa bits in accordance with the summed exponents. In some embodiments, the difference DB [n] may be generated (e.g., by the difference circuit 110) based on subtracting each data element of sums S[y]-S[z] from a “local” maximum exponent sum MaxExpB. The local maximum exponent sum MaxExpB may correspond to a maximum value of the data elements of the sums S[y]-S[z]. In some embodiments, the local maximum exponent sum MaxExpB may be equal to the “global” maximum exponent sum MaxExp. Based on this alignment, the second shifters 113B can generate each instance SP[n] of the shifted products SP[y]-SP[z] having a same exponent using the maximum exponent sum MaxExpB as a baseline.

In addition to the first difference threshold, the shifters 113A and 113B can be controlled (e.g., selectively activated) by a number (e.g., N) of other control signals generated based on comparing corresponding ones of the differences D[1]-D[N] with a second difference threshold (not shown in FIG. 1). In an example where the differences D[1]-D[N] are presented as a normal distribution, the second difference threshold may be determined at one standard deviation above a mean of the normal distribution. In another example where the differences D[1]-D[N] are still presented as a normal distribution, the second difference threshold may be determined at two standard deviations above a mean of the normal distribution. In yet another example where the differences D[1]-D[N] are still presented as a normal distribution, the second difference threshold may be determined at any value of standard deviations above a mean of the normal distribution.

When any of the differences, e.g., D[n] where n is an integer between 1 to N, is equal to or less than the first difference threshold (sometimes referred to as a “small exponent difference”), a corresponding one of the first shifters 113A is deactivated to block the corresponding shifted product SP[n] from being received by the adder circuit 114, and a corresponding one of the second shifters is activated to output the corresponding shifted product SP[n] to the adder circuit 116. Further, when any of the differences, e.g., D[n], is equal to or greater than the second difference threshold (sometimes referred to as a “big exponent difference”), a corresponding one of the first shifters 113A is deactivated to block the corresponding shifted product SP[n] from being received by the adder circuit 114 (e.g., not shifting the corresponding product P[n] or being decoupled from the adder circuit 114), and a corresponding one of the second shifters is also deactivated to block the corresponding shifted product SP[n] from being received by the adder circuit 116 (e.g., not shifting the corresponding product P[n] or being decoupled from the adder circuit 116). The product P[n] with such a big exponent difference may be ignored, in some embodiments.

In other words, the shifting circuit 112 can shift all or some of the products P[1]-P[N], and selectively output the corresponding ones of the shifted products SP[1]-SP[N] to either the adder circuit 114 or the adder circuit 116, based on comparing the respective differences D[1]-D[N] with the first difference threshold and the second difference threshold. As such, a sum of the number of SP[w]-SP[x] (outputted by the first shifters 113A) and the number of SP[y]-SP[z] (outputted by the second shifters 113B) may be less than or equal to N. When one or more of the products P[1]-P[N] are ignored (e.g., having their respective exponent differences D[n] equal to or greater than the second difference threshold), the sum is less than N; and when none of the products P[1]-P[N] is ignored, the sum is equal to N. In various embodiments, the first shifters 113A and the second shifters 113B may output their shifted products to the adder circuit 114 and the adder circuit 116, respectively, in parallel. That is, the adder circuit 114 can receive the shifted products SP[w]-SP[x] and the adder circuit 116 can receive the shifted products SP[y]-SP[z] in parallel.

In some other embodiments, the multiplier circuits 106 can also receive the differences D[1]-D[N], and if a difference D[n] is equal to or greater than the second difference threshold, the multiplier circuits 106 may just ignore multiplication of the corresponding reformatted mantissas InTC and the corresponding reformatted mantissas WtTC. As such, the number of products received by the shifting circuit 112 may be less than N, e.g., P[1] to P[N] except for one or more P[n]. The remaining one of the products P[1]-P[N] may then be selectively shifted by the shifters 113A or the shifters 113B based on comparing their respective differences D[1]-D[N] with the first difference threshold.

In some embodiments, e.g., those in which the data elements InDE and WtDE have the BF16 format, the shifting circuit 112 is configured to generate each of the shifted products, e.g., the SP[0]-SP[N], having a total of 21 bits based on each of the products P[0]-P[N] having a total of 17 bits. In some embodiments, e.g., those in which the data elements InDE and WtDE have the FP16 format, the shifting circuit 112 is configured to generate each of the shifted products, e.g., the SP[0]-SP[N], having a total of 27 bits based on each of the products P[0]-P[N] having a total of 23 bits. The shifting circuit 112 being configured to generate each of the shifted products SP[0]-SP[N] having other total bit numbers based on each of the products P[0]-P[N] having other total bit numbers is within the scope of the present disclosure.

Based on the products P[0]-P[N] having a two's complement format, the shifting circuit 112 is configured to generate the shifted products, e.g., SP[0]-SP[N], having a two's complement format. As discussed above, in the illustrated example of FIG. 1, the first shifters 113A of the shifting circuit 112 are configured to output the shifted products SP[w]-SP[x] to the adder circuit (tree) 114 on a data bus (not shown), and the second shifters 113B of the shifting circuit 112 are configured to output the shifted products SP[y]-SP[z] to the adder circuit (tree) 116 on another data bus (not shown).

The adder trees 114 and 116 are each an electronic circuit, e.g., an IC, including multiple layers of one or more logic gates (not shown), e.g., as discussed above with respect to one or more logic gates A1 (of the summing circuit 108). For example, the adder tree 114 may include a first layer configured to receive the shifted products SP[w]-SP[x], and a last layer configured to generate a sum 115 as a data element corresponding to a sum of the shifted products SP[w]-SP[x]; and the adder tree 116 may include a first layer configured to receive the shifted products SP[y]-SP[z], and a last layer configured to generate a sum 117 as a data element corresponding to a sum of the shifted products SP[y]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

In some embodiments, the sum 115 outputted by the adder tree 114 can be further provided to the shifting circuit 118. The shifting circuit 118 is an electronic circuit, e.g., an IC, including one or more registers and/or logic gates configured to perform a shifting operation on the sum 115, thereby generating shifted sum 115S. As discussed above, the shifted products SP[w]-SP[x] are generated based on the local maximum exponent sum MaxExpA, and the shifted products SP[y]-SP[z] are generated based on the local maximum exponent sum MaxExpB (e.g., equal to the maximum exponent sum MaxExp). Accordingly, the sum 115 may be associated with the exponent of MaxExpA, while the sum 117 may be associated with the exponent of MaxExpB. The shifting circuit 118 can further shift the sum 115 to cause the shifted sum 115 aligned with the sum 117, e.g., having the exponent of MaxExp.

The adder circuit (tree) 120 is an electronic circuit, e.g., an IC, including multiple layers of one or more logic gates (not shown), e.g., as discussed above with respect to one or more logic gates A1 (of the summing circuit 108). For example, the adder tree 120 may include a first layer configured to receive the sums 117 and 115S, and a last layer configured to generate a sum PSTC as a data element corresponding to a sum of the shifted products SP[w]-SP[x] and SP[y]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

The sum PSTC is sometimes referred to as partial sum PSTC or mantissa sum PSTC in some embodiments, having a total number of bits corresponding to the number of bits and number of data elements of the shifted products SP[w]-SP[x] and SP[y]-SP[z]. In some embodiments, the number of bits of sum PSTC is equal to the number of bits of shifted products SP[w]-SP[x] and SP[y]-SP[z] plus a number of bits capable of representing the number of data elements of shifted products SP[w]-SP[x] and SP[y]-SP[z]. In some embodiments, the number of bits of sum PSTC is equal to the number of bits of shifted products SP[w]-SP[x] and SP[y]-SP[z] plus four bits capable of representing 16 data elements of shifted products SP[w]-SP[x] and SP[y]-SP[z].

In some embodiments, e.g., those in which data elements InDE and WtDE have the BF16 format, the adder tree 120 is configured to generate the sum PSTC having a total of 25 bits based on each of the shifted products SP[w]-SP[x] and SP[y]-SP[z] having a total of 21 bits. In some embodiments, e.g., those in which data elements InDE and WtDE have the FP16 format, the adder tree 120 is configured to generate the sum PSTC having a total of 31 bits based on each of the shifted products SP[w]-SP[x] and SP[y]-SP[z] having a total of 27 bits. The adder tree 120 being configured to generate the sum PSTC based on each of the shifted products SP[w]-SP[x] and SP[y]-SP[z] having other total bit numbers is within the scope of the present disclosure.

Based on the shifted products SP[w]-SP[x] and SP[y]-SP[z] having a two's complement format, the adder tree 120 is configured to generate the sum PSTC having a two's complement format, in accordance with various embodiments of the present disclosure. As such, the adder tree 120 is configured to output the sum PSTC to the converter 122 on a data bus (not shown). In some other embodiments, the adder tree 120 may output the sum PSTC to a circuit (not shown) external to the circuit 100.

The converter 122 is an electronic circuit, e.g., an IC, including logic circuitry configured to, in operation, receive the sum PSTC from the adder tree 120, and convert the sum PSTC from two's complement to a sum PSSM having a sign plus mantissa format. The converter 122 is configured to generate the sum PSSM having a same number of bits as that of the sum PSTC. In the embodiment depicted in FIG. 1, the converter 122 is configured to further output the sum PSSM to the converter 124 on a data bus (not shown). In some other embodiments, the converter 122 may output the sum PSSM to a circuit (not shown) external to the circuit 100.

The converter 124 is an electronic circuit, e.g., an IC, including logic circuitry configured to, in operation, receive the sum PSSM from the converter 122 and the maximum exponent sum MaxExp from the difference circuit 110, and convert the sum PSSM from the sign plus mantissa format to a sum PS having an output format based on the sum PSSM and the MaxExp and different from the sign plus mantissa format, e.g., a floating point format as discussed above. In various embodiments of the present disclosure, the converter 124 can generate the sum PS configured to be compatible with a circuit (not shown) external to the circuit 100. For example, the converter 124 is configured to output the sum PS to a circuit (not shown) external to the circuit 100, e.g., a memory array or other instance of the circuit 100 as part of a CNN.

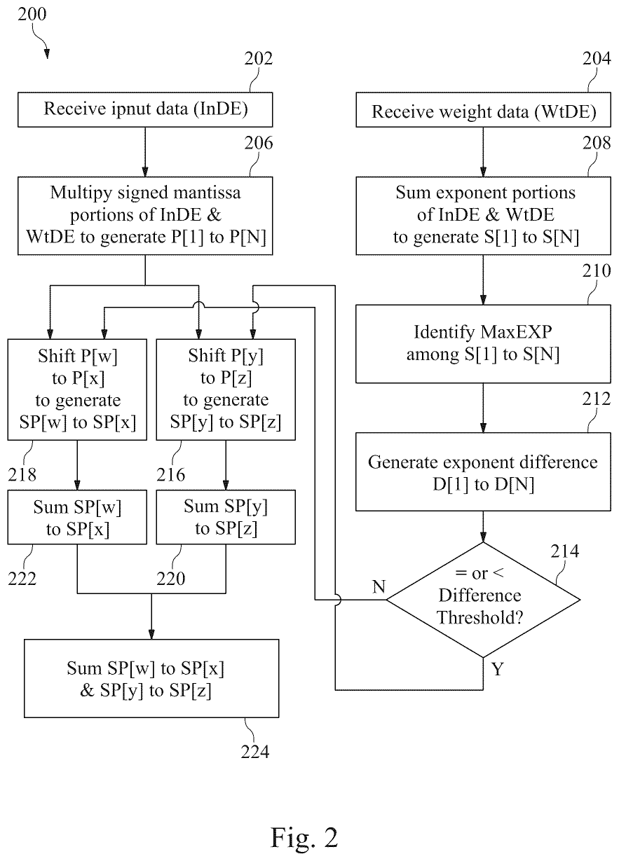

FIG. 2 illustrates a flow chart of an example method 200 for generating a sum based on performing MAC operations on a plural number of input data elements and a plural number of weight data elements, each of the input data elements and the weight data elements including a number of floating point numbers, in accordance with some embodiments of the present disclosure. The method 200 may be performed to operate the circuit 100 (FIG. 1), and thus, in the following discussion of operations of the methods 200, the reference numerals used in FIG. 1 may be reused. It is noted that the method 200 is merely an example and is not intended to limit the present disclosure. Accordingly, it is understood that additional operations may be provided before, during, and after the method 200 of FIG. 2, and that some other operations may only be briefly described herein.

The method 200 starts with operations 202 and 204, in which a number (N) of input data elements (InDE) are received and in which a number (N) of weight data elements (WtDE) are received, respectively, in accordance with some embodiments of the present disclosure. The input data elements InDE and the weight data elements WtDE may each be implemented as a floating point number. The input data elements InDE may correspond to an input word vector, while the weight data elements WtDE may correspond to a weight matrix. Using the circuit 100 depicted in FIG. 1 as an example, the circuit 100 may receive the input data elements InDE and the weight data elements WtDE through the input circuit 104. In some embodiments, the weight data elements WtDE may be stored in storage elements of the memory circuit 102, respectively, and the input data elements InDE can be received through the memory circuit 102 and the input circuit 104.

The method 200 proceeds to operation 206 in which respective signed mantissa portions of the input data elements InDE and the weight data elements WtDE are multiplied with each other to generate products P[1] to P[N], in accordance with some embodiments of the present disclosure. Continuing with the above example of FIG. 1, each of the N input data elements InDE includes a signed mantissa portion, e.g., InS/InM, and each of the N weight data elements WtDE includes a signed mantissa portion, e.g., WtS/WtM. The multiplier circuits 106 can each include a number of logic gates operatively serving as a multiplier (e.g., M1) configured to multiply the signed mantissa portion of a corresponding one of the N input data elements InDE with the signed mantissa portion of a corresponding one of the N weight data elements WtDE, so as to generate a corresponding one of the products P[1] to P[N]. Prior to the multiplication, the multiplier circuits 106 can each reformat or otherwise transform the signed mantissa portions of the corresponding input data element InDE and weight data element WtDE into a two's complement mantissa InTC and a two's complement mantissa WtTC, respectively.

The method 200 proceeds to operation 208 in which respective exponent portions of the input data elements InDE and the weight data elements WtDE are summed together to generate exponent sums S[1]-S[N], in accordance with some embodiments of the present disclosure. Continuing with the above example of FIG. 1, each of the N input data elements InDE includes an exponent portion, e.g., InE, and each of the N weight data elements WtDE includes an exponent portion, e.g., WtE. The multiplier circuits 106 can each include a number of logic gates operatively serving as an adder (e.g., A1) configured to sum the exponent portion of a corresponding one of the N input data elements InDE and the exponent portion of a corresponding one of the N weight data elements WtDE, so as to generate a corresponding one of the exponent sums S[1] to S[N].

The method 200 proceeds to operation 210 in which a maximum exponent sum MaxExp among the exponent sums S[1] to S[N] is identified, in accordance with some embodiments of the present disclosure. Continuing with the above example of FIG. 1, the difference circuit 110 can receive the exponent sums S[1] to S[N], and include a number of logic gates operatively serving as a comparator (e.g., L1) configured to identify the maximum exponent sum MaxExp from the exponent sums S[1] to S[N].

The method 200 proceeds to operation 212 in which exponent differences D[1] to D[N] are generated, in accordance with some embodiments of the present disclosure. Continuing with the above example of FIG. 1, the difference circuit 110 can include a number of logic gates operatively serving as a subtractor (e.g., B1) configured to subtract each of the exponent sums S[1] to S[N] from the maximum exponent sum MaxExp, so as to generate a corresponding one of the exponent differences D[1] to D[N].

The method 200 proceeds to determination operation 214 in which each of the exponent differences D[1] to D[N] is compared with a difference threshold, in accordance with some embodiments of the present disclosure. Continuing with the above example of FIG. 1, the circuit 100 can include a number of logic gates operatively serving as a number of comparators (not shown in FIG. 1), each of which is configured to compare a corresponding one of the exponent differences D[1] to D[N] with the difference threshold and generate a respective control signal. In some embodiments, between each of the exponent differences D[1] to D[N] and the corresponding ones of the first shifters 113A and the second shifters 113B, such a comparator may exist. For example, if any of the exponent difference, e.g., D[n], is less than or equal to the difference threshold, the comparator can generate a control signal with a first logic state to deactivate corresponding ones of the first shifters 113A, while concurrently activating corresponding ones of the second shifters 113B (operation 216); and if any of the exponent difference, e.g., D[n], is greater than the difference threshold, the comparator can generate the control signal with a second, opposite logic state to deactivate a corresponding one of the second shifters 113B, while concurrently activating a corresponding one of the first shifters 113A (operation 218).

In operation 216, upon determining that the exponent differences D[y] to D[z] are each less than or equal to the difference threshold (e.g., by receiving the control signals discussed above), the first shifters 113A can block the products P[y] to P[z] from being shifted or being received by the adder tree 114. Concurrently, the second shifters 113B can shift the products P[y] to P[z] as shifted products SP[y] to SP[z], respectively, and send the shifted products SP[y] to SP[z] to the adder tree 116. The second shifters 113B can shift the products P[y] to P[z] using the local maximum exponent sum MaxExpB as a baseline. In operation 218, upon determining that the exponent differences D[w] to D[x] are each greater than the difference threshold (e.g., by receiving the control signals discussed above), the second shifters 113B can block the products P[w] to P[x] from being shifted or being received by the adder tree 116. Concurrently, the first shifters 113A can shift the products P[w] to P[x] as shifted products SP[w] to SP[x], respectively, and send the shifted products SP[w] to SP[x] to the adder tree 114. The first shifters 113A can shift the products P[w] to P[x] using the local maximum exponent sum MaxExpA as a baseline.

Following operation 216, the method 200 proceeds to operation 220 in which the shifted products SP[y] to SP[z] are summed, in accordance with some embodiments of the present disclosure. Continuing with the above example of FIG. 1, the circuit 100 can include the adder tree 116 to sum the shifted products SP[y] to SP[z] to generate the sum 117. Following operation 218, the method 200 proceeds to operation 222 in which the shifted products SP[w] to SP[x] are summed, in accordance with some embodiments of the present disclosure. Continuing with the above example of FIG. 1, the circuit 100 can include the adder tree 114 to sum the shifted products SP[w] to SP[x] to generate the sum 115.

The method 200 proceeds to operation 224 in which the shifted products SP[y] to SP[z] and the shifted products SP[w] to SP[x] are all summed together, in accordance with some embodiments of the present disclosure. Continuing with the above example of FIG. 1, the circuit 100 can include the adder tree 120 to sum the shifted products SP[y] to SP[z] and the shifted products SP[w] to SP[x] as the partial sum PSTC. Alternatively stated, the adder tree 120 can combine the sum 115 and the sum 117 as the partial sum PSTC. In some embodiments of the present disclosure, prior to being combined with the sum 117 (operation 224), the sum 115 may first be shifted as shifted sum 115S using the local maximum exponent sum MaxExpB, which may be equal to MaxExp, as a baseline.

FIG. 3 illustrates an example schematic diagram 300 of a portion of the circuit 100 (FIG. 1), in accordance with some embodiments of the present disclosure. The schematic diagram 300 of FIG. 3 presents an example where sixteen input data elements InDE and sixteen weight data elements WtDE are received or retrieved by the circuit 100. However, the number of input data elements InDE and the number of weight data elements WtDE can be less than or greater than sixteen, while remaining within the scope of the present disclosure.

As shown, the schematic diagram 300 includes components 302, 304, 306A, 306B, 308, 310, 312, and 314. The component 302 may correspond to the logic gates L1 of the difference circuit 110; the component 304 may correspond to the logic gates B1 of the difference circuit 110; the component 306A may correspond to the first shifters 113A of the shifting circuit 112; the component 306B may correspond to the second shifters 113B of the shifting circuit 112; the component 308 may correspond to the adder tree 114; the component 310 may correspond to the adder tree 116; the component 312 may correspond to the shifting circuit 118; and the component 314 may correspond to the adder tree 120.

In such a configuration, the component 302 can receive exponent sums S[1] to S[16], and output a maximum one of the exponent sums S[1] to S[16] as a maximum exponent sum MaxExp. The component 304 can also receive the exponent sums S[1] to S[16], and generate exponent differences D[1] to D[16] based on subtracting each of the exponent sums S[1] to S[16] from the maximum exponent sum MaxExp. Stated another way, each of the exponent differences D[1] to D[16] is a difference between a corresponding one of the exponent sums S[1] to S[16] and the maximum exponent sum MaxExp. The component 306A includes a plural number of shifters, each of which is configured to receive (e.g., controlled by) a corresponding one of the exponent differences D[1] to D[16]; and the component 306B includes a plural number of shifters, each of which is configured to receive (e.g., controlled by) a corresponding one of the exponent differences D[1] to D[16]. The shifters of the component 306A are configured to selectively shift the signed mantissa products P[1] to P[16] to the component 308 based on the respective exponent differences D[1] to D[16], and the shifters of the component 306B are configured to selectively shift the signed mantissa products P[1] to P[16] to the component 310 based on the respective exponent differences D[1] to D[16].

In some embodiments, each of the shifters of the component 306A and a corresponding one of the shifters of the component 306B may be alternately activated to shift the corresponding one of the signed mantissa products P[1] to P[16]. For example in FIG. 3, in response to the exponent difference D[15] being equal to or less than a preset difference threshold, one of the shifters of the component 306A controlled based on the exponent difference D[15] may be deactivated, while the corresponding one of the shifters of the component 306B controlled based on the same exponent difference D[15] may be activated. Continuing with the above example, after the component 308 sums the shifted signed mantissa products P[1] to P[16] except for P[15], with the component 310 summing the shifted signed mantissa products P[15], the component 312 can shift the sum outputted by the component 308. The component 314 can then sum the shifted sum outputted by the component 308 and the sum outputted by the component 310 as partial sum PSTC.

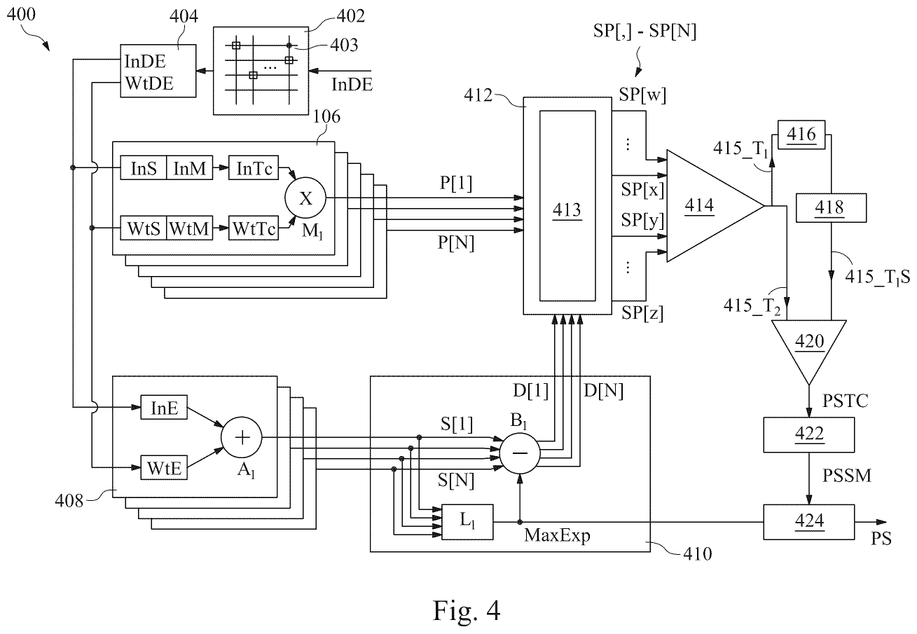

FIG. 4 illustrates a block diagram of another data computation circuit 400, in accordance with some embodiments of the present disclosure. In the illustrated embodiment depicted in FIG. 4, the data computation circuit 400, also referred to as circuit 400 or memory circuit 400, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (N) of weight data elements WtDE. In various embodiments, each of the input data elements InDE and the weight data elements WtDE may include a floating point number.

As shown, the circuit 400 includes a memory circuit 402, an input circuit 404, a number of multiplier circuits 406, a number of summing circuits 408, a difference circuit 410, a first shifting circuit 412, a first adder circuit (or adder tree) 414, a latch circuit 416, a second shifting circuit 418, a second adder circuit (or adder tree) 420, a first converter 422, and a second converter 424. In some embodiments, the number of multiplier circuits 406 may correspond to the number of summing circuits 408. For example, the circuit 400 may include N (the number of weight/input data elements WtDE/InDE) multiplier circuits 406 and N (the number of weight/input data elements WtDE/InDE) summing circuits 408. It should be appreciated that the block diagram of the circuit depicted in FIG. 4 is simplified, and thus, the circuit 400 can include any of various other components while remaining within the scope of the present disclosure.

The memory circuit 402 may include one or more memory arrays and one or more corresponding circuits. The memory arrays are each a storage device including a number of storage elements 403, each of the storage elements 403 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 403. In some embodiments, a logical state corresponds to a physical property, e.g., a resistance or magnetic orientation, of a portion or all of a storage element 403.

In some embodiments, the storage element 403 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, an SRAM cell includes a multi-track SRAM cell. In some embodiments, an SRAM cell includes a length at least two times greater than a width.

In some embodiments, the storage element 403 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 402 can include a number of circuits to access or otherwise control the memory arrays. For example, the memory circuit 402 may include a number of (e.g., word line) drivers operatively coupled to the memory arrays. The drivers can apply signals (e.g., voltages) to the corresponding storage elements 403 so as to allow those storage elements 403 to be accessed (e.g., programmed, read, etc.). For another example, the memory circuit 402 may include a number of programming circuits and/or read circuits that are operatively coupled to the memory arrays.

The memory arrays of the memory circuit 402 are each configured to store a number of the weight data elements WtDE. In some embodiments, the programming circuits may write the weight data elements WtDE into corresponding storage elements 403 of the memory arrays, respectively, while the reading circuit may read bits written into the storage elements 403, so as to verify or otherwise test whether the written weight data elements WtDE are correct. The drivers of the memory circuit 402 can include or be operatively coupled to a number of input activation latches that are configured to receive and temporarily store the input data elements InDE. In some other embodiments, such input activation latches may be part of the input circuit 404, which can further include a number of buffers that are configured to temporarily store the weight data elements WtDE retrieved from the memory arrays of the memory circuit 402. As such, the input circuit 404 can receive the input data elements InDE and the weight data elements WtDE.

In various embodiments of the present disclosure, the input word vector (including, e.g., the input data elements InDE) and the weight matrix (including, e.g., the weight data elements WtDE), on which the circuit 400 is configured to perform MAC operations, each include a number of floating point numbers. As such, each of the data elements InDE and weight data elements WtDE includes a sign bit, a plural number of exponent bits, and a plural number of mantissa bits (sometimes referred to as fraction bits).

For example, each of the data elements InDE and weight data elements WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

In some embodiments, each of the data elements InDE and the weight data elements WtDE has a FP16 format, also referred to as a half precision format, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one. In some other embodiments, each of the data elements InDE and the weight data elements WtDE has a floating-point format other than a BF16 or FP16 format, e.g., another 16-bit format, a 32-bit, 64-bit, 128-bit, or 256-bit format, or a 40-bit or 80-bit extended precision format. The sign and mantissa of a data element representing a floating-point number are collectively referred to as a signed mantissa of the floating-point number. The MSB of a mantissa is referred to as a hidden bit or hidden MSB.

Referring still to FIG. 4, the input circuit 404 is configured to output entireties of each data element of data elements InDE and WtDE to each of the multiplier circuits 406 and the summing circuits 408. In some embodiments, the input circuit 404 is configured to output the signed mantissa of each data element to the multiplier circuit 406 and the exponent of each data element to the summing circuit 408, which will be described as follows.

The multiplier circuits 406 are each an electronic circuit, e.g., an integrated circuit (IC), configured to receive, e.g., from the input circuit 404, a sign bit InS and a mantissa InM (collectively a signed mantissa InS/InM) of each of the N data elements InDE, and a sign bit WtS and a mantissa WtM (collectively a signed mantissa WtS/WtM) of each of the N data elements WtDE. The summing circuit 408 are each an electronic circuit, e.g., an IC, configured to receive, e.g., from the input circuit 404, an exponent InE of each of the N data elements InDE, and an exponent WtE of each of the N data elements WtDE.

The multiplier circuits 406 may each include one or more data registers (not shown) configured to receive the instances of signed mantissas InS/InM and WtS/WtM. In the embodiment depicted in FIG. 4, the multiplier circuit 406 is configured to receive the instances of signed mantissas InS/InM and WtS/WtM corresponding to data elements InDE and WtDE. In some other embodiments, the multiplier circuit 406 includes the one or more data registers configured to receive the instances of signed mantissas InS/InM and/or WtS/WtM including the hidden MSBs. In some embodiments, the multiplier circuit 406 includes the one or more data registers configured to add the hidden MSBs to the received instances of signed mantissas InS/InM and/or WtS/WtM.

The multiplier circuit 406 may further include logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WTC. Reformatted mantissa InTC has a same number of bits as signed mantissa InS/InM, and reformatted mantissa WTC has a same number of bits as signed mantissa WtS/WtM.

The multiplier circuit 406 may further include one or more logic gates M1 configured to, in operation, multiply some or all of the instances of reformatted mantissas InTC with some or all of the instances of reformatted mantissas WtTC, thereby generating N products, e.g., P[1] to P[N]. In various embodiments, the one or more logic gates M1 include one or more AND or NOR gates or other circuits suitable for performing some or all of a multiplication operation. The one or more logic gates M1 are configured to, in operation, generate each of the products P[1] to P[N] as a two's complement data element including a number of bits equal to twice the number of bits of reformatted mantissas InTC and WtTC minus one.

The multiplier circuits 406 are configured to, in operation, generate the number N of products P[1] to P[N]. For example, the multiplier circuits 406 can generate the number N of products P[1]-P[N] equal to sixteen. In some other embodiments, the multiplier circuits 106 can generate the number N of products P[1]-P[N] fewer or greater than sixteen.

In some embodiments, e.g., those in which data elements InDE and WtDE have the BF16 format, the multiplier circuit 406 is configured to generate each of the products P[1]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, the multiplier circuit 406 is configured to generate each of products P[1]-P[N] having a total of 23 bits based on each of signed mantissas InS/InM and WtS/WtM and reformatted mantissas InTC and WtTC having a total of 12 bits. Embodiments in which the multiplier circuit 406 is configured to generate each of products P[1]-P[N] having other total bit numbers based on each of signed mantissas InS/InM and WtS/WtM and reformatted mantissas InTC and WtTC having other total bit numbers are within the scope of the present disclosure.

The multiplier circuit 406 is thereby configured to, in operation, perform multiplication and reformatting operations on sign and mantissa bits of input data elements InDE and weight data elements WtDE so as to generate two's complement products P[1]-P[N]. The multiplier circuit 406 is configured to output products P[1]-P[N] to the shifting circuit 112 on a data bus (not shown).

The summing circuits 408 each include one or more data registers (not shown) configured to receive the instances of exponents InE and WtE corresponding to the number of data elements of data elements InDE and WtDE discussed above with respect to the multiplier circuit 406.

The summing circuits 408 each include one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The respective logic gates A1 of the summing circuits 408 are configured to generate exponent sums S[1]-S[N] as data elements having a total number of bits equal to the number of bits of each of exponents InE and WtE plus one.

The summing circuits 408 are configured to, in operation, generate the exponent sums S[1]-S[N] having the total number N and an ordering of data elements corresponding to the total number N and ordering of the data elements of the products P[1]-P[N] discussed above with respect to the multiplier circuit 406. Accordingly, for a total of N combinations of data elements InDE and WtDE, each n^{th} combination corresponds to both the n^{th} exponent sum S[n] of the exponent sums S[1]-S[N] and the n^{th} product P[n] of the products P[1]-P[N].

In some embodiments, e.g., those in which the data elements InDE and WtDE have the BF16 format, the summing circuit 408 is configured to generate each corresponding one of the exponent sums S[1]-S[N] having a total of nine bits based on each of the exponents InE and WtE having a total of eight bits. In some embodiments, e.g., those in which the data elements InDE and WtDE have the FP16 format, the summing circuit 408 is configured to generate each of the sums S[0]-S[N] having a total of six bits based on each of exponents InE and WtE having a total of five bits. The summing circuit 408 being configured to generate each of the exponent sums S[1]-S[N] having other total bit numbers based on each of exponents InE and WtE having other total bit numbers is within the scope of the present disclosure. The summing circuits 408 are configured to output the exponent sums S[1]-S[N] to the difference circuit 410 on a data bus (not shown).

The difference circuit 410 is an electronic circuit, e.g., an IC, including one or more logic gates L1 and one or more logic gates B1, each configured to receive the exponent sums S[1]-S[N] from the summing circuits 408. The one or more logic gates L1 may sometimes referred to as a selector, and the one or more logic gates B1 may sometimes be referred to as a subtractor. The one or more logic gates L1 are configured to, in operation, generate a maximum exponent sum MaxExp as a data element having a value equal to a maximum value of the data elements of the exponent sums S[1]-S[N] and having a number of bits equal to those of the data elements of the exponent sums S[1]-S[N]. The one or more logic gates L1 are configured to output maximum exponent sum MaxExp to the one or more logic gates B1 and to the converter circuit 424, as discussed below.

The one or more logic gates B1 are configured to, in operation, generate differences D[1]-D[N] by subtracting each data element of the exponent sums S[1]-S[N] from maximum exponent sum MaxExp. The differences D[1]-D[N] thereby have the total number N and ordering of data elements corresponding to that of the exponent sums S[1]-S[N] and the products P[1]-P[N] discussed above. In the embodiment depicted in FIG. 4, the one or more logic gates B1 are configured to output differences D[1]-D[N] to the shifting circuit 412 on a data bus (not shown). In some embodiments, the one or more logic gates B1 are not configured to output the differences D[1]-D[N] to the multiplier circuits 406, and the multiplier circuits 406 are each configured to generate each instance P[n] of products P[1]-P[N] by always performing the multiplying operation. In some other embodiments, the one or more logic gates B1 are configured to output the differences D[1]-D[N] to the multiplier circuits 406, respectively, and the multiplier circuits 406 are each configured to generate each instance P[n] of products P[1]-P[N] by selectively performing the multiplying operation based on a corresponding instance D[n].

The shifting circuit 412 is an electronic circuit, e.g., an IC, including one or more registers and/or logic gates configured to perform a shifting operation on each instance P[n] of the products P[1]-P[N] based on the value of the corresponding instance D[n] of the differences D[1]-D[N].

Each instance P[n] of the products P[1]-P[N] is based on the sign and mantissa of a corresponding combination of data elements InDE and WtDE, and each instance D[n] of the differences D[1]-D[N] is based on the sum of the exponents of the same combination. The shifting circuit 412 is configured to, in operation, right-shift each instance P[n] of the products P[1]-P[N] by an amount equal to the corresponding difference D[n], thereby generating shifted products SP[1]-SP[N] in which sign and mantissa bits are aligned in accordance with the summed exponents used to generate the differences D[1]-D[N]. Based on this alignment, the shifting circuit 412 is configured to generate each instance SP[n] of the shifted products SP[1]-SP[N] having a same exponent using the maximum exponent sum MaxExp as a baseline.

To compensate for the right-shifting operation, the shifting circuit 412 can add instances of the sign bit (zero or one) of each product P[n] as the leftmost bits of the corresponding shifted product SP[n]. The number of added instances of the sign bit is equal to the amount of the right shift as determined by the corresponding difference D[n].

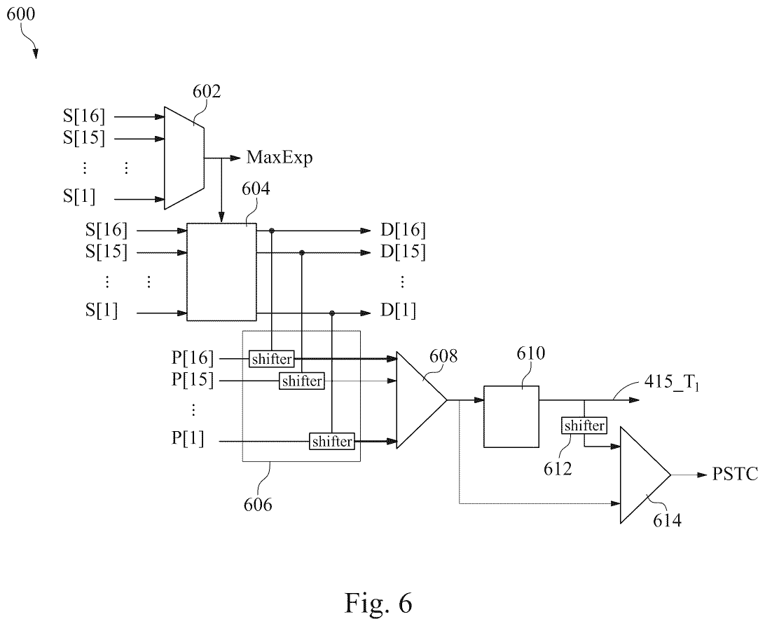

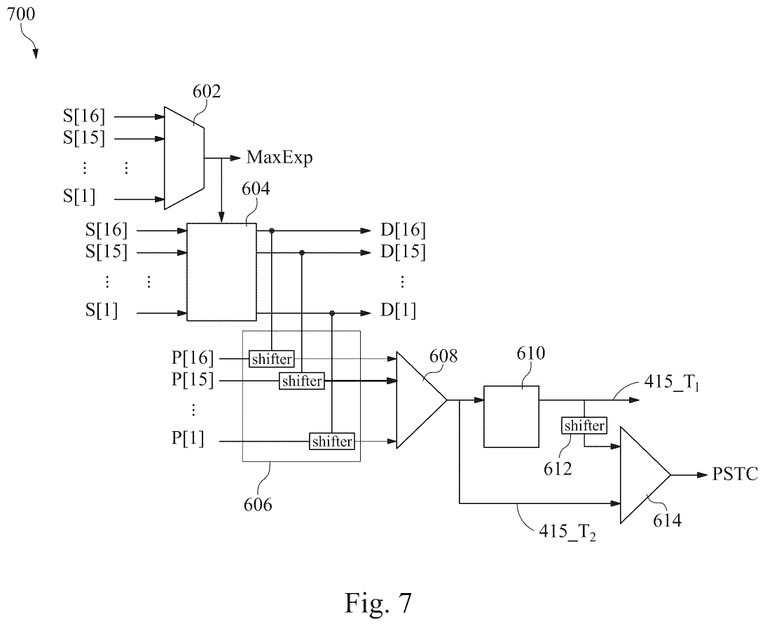

In the illustrated embodiment of FIG. 4, the multiplier circuit 406 can generate the corresponding instance P[n] of the products P[1]-P[N] by performing the multiplying operation, as discussed above. The shifting circuit 412 can include a number (e.g., N) of shifters 413 (which will be descried with respect to FIGS. 6-7). The shifters 413 can receive the products P[1]-P[N] from the multiplier circuits 406, selectively output (e.g., shift) one or more first ones of the shifted products SP[1]-SP[N] to the adder circuit 414 based on the respective differences D[1]-D[N] during a first time period, and selectively output (e.g., shift) one or more second ones of the shifted products SP[1]-SP[N] to the adder circuit 414 based on the respective differences D[1]-D[N] during a second time period. For example in FIG. 4, the first shifted products outputted to the adder circuit 414 (during the first time period) may include SP[w]-SP[x], and the second shifted products outputted to the adder circuit 414 (during the second time period) may include SP[y]-SP[z], where “w,” “x,” “y,” and “z” may each be one of the integers from 1 to N. In one aspect of the present disclosure, a sum of the number of SP[w]-SP[x] and the number of SP[y]-SP[z] may be equal to N. In another aspect of the present disclosure, a sum of the number of SP[w]-SP[x] and the number of SP[y]-SP[z] may be less than N.

The shifters 413 can be controlled (e.g., selectively activated) by a number (e.g., N) of control signals generated based on comparing corresponding ones of the differences D[1]-D[N] with a first difference threshold (not shown in FIG. 4). The first difference threshold can be configured based on a distribution of the differences D[1]-D[N]. In an example where the differences D[1]-D[N] are presented as a normal distribution, the first difference threshold may be determined at one standard deviation below a mean of the normal distribution. In another example where the differences D[1]-D[N] are still presented as a normal distribution, the first difference threshold may be determined at two standard deviations below a mean of the normal distribution. In yet another example where the differences D[1]-D[N] are still presented as a normal distribution, the first difference threshold may be determined at any value of standard deviations below a mean of the normal distribution.

When any of the differences, e.g., D[n] where n is an integer between 1 to N, is equal to or less than the first difference threshold (sometimes referred to as a “small exponent difference”), a corresponding one of the shifters 413 is deactivated to block the corresponding shifted product SP[n] from being received by the adder circuit 414 (e.g., not shifting the corresponding product P[n] or being decoupled from the adder circuit 114) during the first time period. During the second time period, the corresponding one of the shifters 413 is activated to shift the previously blocked product P[n] and output it to the adder circuit 414. Equivalently, when each difference D[n] is greater than the first difference threshold (sometimes referred to as a “normal exponent difference”), a corresponding one of the shifters 413 is activated to output the corresponding shifted product SP[n] to the adder circuit 414 during the first time period. During the second time period, the corresponding one of the shifters 413 is deactivated to block the previously shifted product SP[n] from being received by the adder circuit 414.

In other words, the shifting circuit 412 can shift all of the products P[1]-P[N], and selectively output the shifted products SP[1]-SP[N] to the adder circuit 414 at different timings based on comparing the respective differences D[1]-D[N] with the first difference threshold. As such, a sum of the number of SP[w]-SP[x] (outputted by the shifters 413 during the first time period) and the number of SP[y]-SP[z] (outputted by the shifters 413 during the second time period) may be equal to N.

Further, to generate the SP[w]-SP[x] during the first time period, the shifters 413 may right-shift each instance P[n] of the products P[w]-P[x] by an amount equal to a corresponding difference DA [n], thereby aligning sign and mantissa bits in accordance with the summed exponents. In some embodiments, the difference DA [n] may be generated (e.g., by the difference circuit 410) based on subtracting each data element of sums S[w]-S[x] from a “local” maximum exponent sum MaxExpA. The local maximum exponent sum MaxExpA may correspond to a maximum value of the data elements of the sums S[w]-S[x]. Based on this alignment, the shifters 413 can generate each instance SP[n] of the shifted products SP[w]-SP[x] having a same exponent using the maximum exponent sum MaxExpA as a baseline. Similarly, during the second time period, the shifters 413 may right-shift each instance P[n] of the products P[y]-P[z] by an amount equal to a corresponding difference DB [n], thereby aligning sign and mantissa bits in accordance with the summed exponents. In some embodiments, the difference DB [n] may be generated (e.g., by the difference circuit 410) based on subtracting each data element of sums S[y]-S[z] from a “local” maximum exponent sum MaxExpB. The local maximum exponent sum MaxExpB may correspond to a maximum value of the data elements of the sums S[y]-S[z]. In some embodiments, the local maximum exponent sum MaxExpB may be equal to the “global” maximum exponent sum MaxExp. Based on this alignment, the shifters 413 can generate each instance SP[n] of the shifted products SP[y]-SP[z] having a same exponent using the maximum exponent sum MaxExpB as a baseline.

In addition to the first difference threshold, the shifters 413 can be controlled (e.g., selectively activated) by a number (e.g., N) of other control signals generated based on comparing corresponding ones of the differences D[1]-D[N] with a second difference threshold (not shown in FIG. 1). In an example where the differences D[1]-D[N] are presented as a normal distribution, the second difference threshold may be determined at one standard deviation above a mean of the normal distribution. In another example where the differences D[1]-D[N] are still presented as a normal distribution, the second difference threshold may be determined at two standard deviations above a mean of the normal distribution. In yet another example where the differences D[1]-D[N] are still presented as a normal distribution, the second difference threshold may be determined at any value of standard deviations above a mean of the normal distribution.

When any of the differences, e.g., D[n] wherein n is an integer between 1 to N, is equal to or less than the first difference threshold (sometimes referred to as a “small exponent difference”), a corresponding one of the shifters 413 is deactivated to block the corresponding shifted product SP[n] from being received by the adder circuit 414 during a first time period, and the corresponding one of the shifters is then activated during a second time period to output the corresponding shifted product SP[n] to the adder circuit 414. Further, when any of the difference D[n] is equal to or greater than the second difference threshold (sometimes referred to as a “big exponent difference”), a corresponding one of the shifters 413 is deactivated to block the corresponding shifted product SP[n] from being received by the adder circuit 414 (e.g., not shifting the corresponding product P[n] or being decoupled from the adder circuit 414), and the corresponding one of the shifters may not be activated during the second time period or any following timing. The product P[n] with such a big exponent difference may be ignored, in some embodiments.

In other words, the shifting circuit 412 can shift all or some of the products P[1]-P[N], and selectively output the corresponding ones of the shifted products SP[1]-SP[N] to the adder circuit 414, based on comparing the respective differences D[1]-D[N] with the first difference threshold and the second difference threshold. As such, a sum of the number of SP[w]-SP[x] (outputted by the shifters 413 during the first time period) and the number of SP[y]-SP[z] (outputted by the shifters 413 during the second time period) may be less than or equal to N. When one or more of the products P[1]-P[N] are ignored (e.g., having their respective exponent differences D[n] equal to or greater than the second difference threshold), the sum is less than N; and when none of the products P[1]-P[N] is ignored, the sum is equal to N.

In some other embodiments, the multiplier circuits 406 can also receive the differences D[1]-D[N], and if a difference D[n] is equal to or greater than the second difference threshold, the multiplier circuits 406 may just ignore multiplication of the corresponding reformatted mantissas InTC and the corresponding reformatted mantissas WtTC. As such, the number of products received by the shifting circuit 412 may be less than N, e.g., P[1] to P[N] except for one or more P[n]. The remaining one of the products P[1]-P[N] may then be selectively shifted by the shifters 413 based on comparing their respective differences D[1]-D[N] with the first difference threshold.

In some embodiments, e.g., those in which the data elements InDE and WtDE have the BF16 format, the shifting circuit 412 is configured to generate each of the shifted products, e.g., the SP[0]-SP[N], having a total of 21 bits based on each of the products P[0]-P[N] having a total of 17 bits. In some embodiments, e.g., those in which the data elements InDE and WtDE have the FP16 format, the shifting circuit 412 is configured to generate each of the shifted products, e.g., the SP[0]-SP[N], having a total of 27 bits based on each of the products P[0]-P[N] having a total of 23 bits. The shifting circuit 412 being configured to generate each of the shifted products SP[0]-SP[N] having other total bit numbers based on each of the products P[0]-P[N] having other total bit numbers is within the scope of the present disclosure.

Based on the products P[0]-P[N] having a two's complement format, the shifting circuit 412 is configured to generate the shifted products, e.g., SP[0]-SP[N], having a two's complement format. As discussed above, in the illustrated example of FIG. 4, the shifters 413 are configured to output the shifted products SP[w]-SP[x] to the adder circuit (tree) 414 on a data bus (not shown) during the first time period, and then output the shifted products SP[y]-SP[z] to the adder circuit (tree) 414 on the same or another data bus (not shown) during the second time period.

The adder tree 414 is an electronic circuit, e.g., an IC, including multiple layers of one or more logic gates (not shown), e.g., as discussed above with respect to one or more logic gates AI (of the summing circuit 408). For example, during the first time period, the adder tree 414 may include a first layer configured to receive the shifted products SP[w]-SP[x], and a last layer configured to generate a sum 415_T₁ as a data element corresponding to a sum of the shifted products SP[w]-SP[x]; and, during the second time period, the same adder tree 414 may utilize the first layer to receive the shifted products SP[y]-SP[z], and the last layer to generate a sum 415_T₂ as a data element corresponding to a sum of the shifted products SP[y]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

In some embodiments, the sum 415_T₁ outputted by the adder tree 414 during the first time period can be further provided to the latch circuit 416 then to the shifting circuit 418. The latch circuit 416 is an electronic circuit, e.g., an IC, including one or more registers and/or logic gates configured to temporarily store the sum 415_T₁ and hold the sum 415_T₁ until a new value of the sum 415_T₁ is provided by the adder tree 414. The shifting circuit 418 is an electronic circuit, e.g., an IC, including one or more registers and/or logic gates configured to perform a shifting operation on the sum 415_T₁, thereby generating shifted sum 415_T₁S. As discussed above, the shifted products SP[w]-SP[x] are generated based on the local maximum exponent sum MaxExpA during the first time period, and the shifted products SP[y]-SP[z] are generated based on the local maximum exponent sum MaxExpB (e.g., equal to the maximum exponent sum MaxExp) during the second time period. Accordingly, the sum 415_T₁ may be associated with the exponent of MaxExpA, while the sum 415_T₂ may be associated with the exponent of MaxExpB. The shifting circuit 418 can further shift the sum 415_T₁ to cause the shifted sum 415_T₁S aligned with the sum 415_T₂, e.g., having the exponent of MaxExp.

The adder circuit (tree) 420 is an electronic circuit, e.g., an IC, including multiple layers of one or more logic gates (not shown), e.g., as discussed above with respect to one or more logic gates A1 (of the summing circuit 108). For example, the adder tree 420 may include a first layer configured to receive the sums 415_T₂ and 415_T₁S, and a last layer configured to generate a sum PSTC as a data element corresponding to a sum of the shifted products SP[w]-SP[x] and SP[y]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

The sum PSTC is sometimes referred to as partial sum PSTC or mantissa sum PSTC in some embodiments, having a total number of bits corresponding to the number of bits and number of data elements of the shifted products SP[w]-SP[x] and SP[y]-SP[z]. In some embodiments, the number of bits of sum PSTC is equal to the number of bits of shifted products SP[w]-SP[x] and SP[y]-SP[z] plus a number of bits capable of representing the number of data elements of shifted products SP[w]-SP[x] and SP[y]-SP[z]. In some embodiments, the number of bits of sum PSTC is equal to the number of bits of shifted products SP[w]-SP[x] and SP[y]-SP[z] plus four bits capable of representing 16 data elements of shifted products SP[w]-SP[x] and SP[y]-SP[z].

In some embodiments, e.g., those in which data elements InDE and WtDE have the BF16 format, the adder tree 420 is configured to generate the sum PSTC having a total of 25 bits based on each of the shifted products SP[w]-SP[x] and SP[y]-SP[z] having a total of 21 bits. In some embodiments, e.g., those in which data elements InDE and WtDE have the FP16 format, the adder tree 420 is configured to generate the sum PSTC having a total of 31 bits based on each of the shifted products SP[w]-SP[x] and SP[y]-SP[z] having a total of 27 bits. The adder tree 420 being configured to generate the sum PSTC based on each of the shifted products SP[w]-SP[x] and SP[y]-SP[z] having other total bit numbers is within the scope of the present disclosure.

Based on the shifted products SP[w]-SP[x] and SP[y]-SP[z] having a two's complement format, the adder tree 420 is configured to generate the sum PSTC having a two's complement format, in accordance with various embodiments of the present disclosure. As such, the adder tree 420 is configured to output the sum PSTC to the converter 422 on a data bus (not shown). In some other embodiments, the adder tree 420 may output the sum PSTC to a circuit (not shown) external to the circuit 400.

The converter 422 is an electronic circuit, e.g., an IC, including logic circuitry configured to, in operation, receive the sum PSTC from the adder tree 420, and convert the sum PSTC from two's complement to a sum PSSM having a sign plus mantissa format. The converter 422 is configured to generate the sum PSSM having a same number of bits as that of the sum PSTC. In the embodiment depicted in FIG. 4, the converter 422 is configured to further output the sum PSSM to the converter 424 on a data bus (not shown). In some other embodiments, the converter 422 may output the sum PSSM to a circuit (not shown) external to the circuit 400.

The converter 424 is an electronic circuit, e.g., an IC, including logic circuitry configured to, in operation, receive the sum PSSM from the converter 422 and the maximum exponent sum MaxExp from the difference circuit 410, and convert the sum PSSM from the sign plus mantissa format to a sum PS having an output format based on the sum PSSM and the MaxExp and different from the sign plus mantissa format, e.g., a floating point format as discussed above. In various embodiments of the present disclosure, the converter 424 can generate the sum PS configured to be compatible with a circuit (not shown) external to the circuit 400. For example, the converter 424 is configured to output the sum PS to a circuit (not shown) external to the circuit 400, e.g., a memory array or other instance of the circuit 400 as part of a CNN.

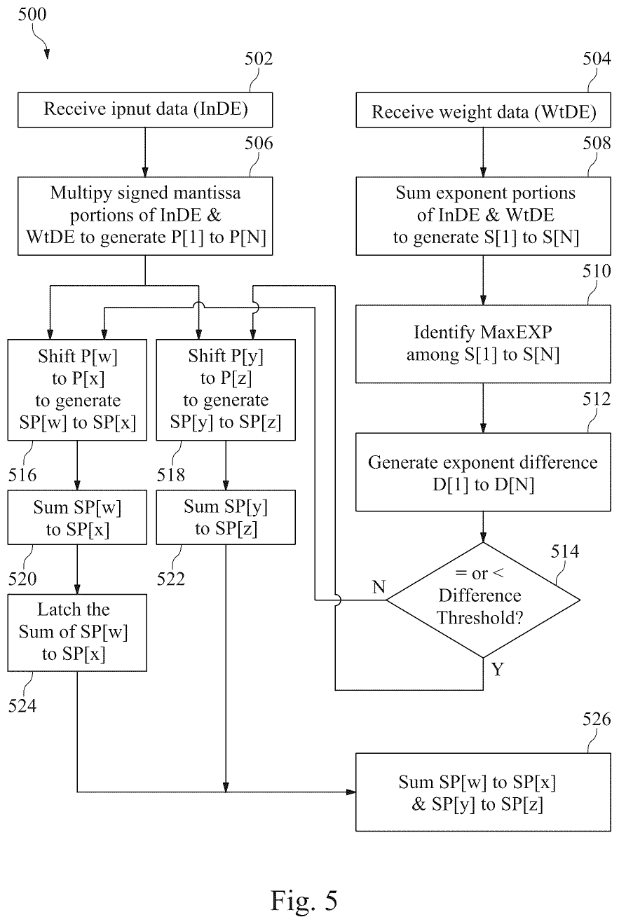

FIG. 5 illustrates a flow chart of another example method 500 for generating a sum based on performing MAC operations on a plural number of input data elements and a plural number of weight data elements, each of the input data elements and the weight data elements including a number of floating point numbers, in accordance with some embodiments of the present disclosure. The method 500 may be performed to operate the circuit 400 (FIG. 4), and thus, in the following discussion of operations of the methods 500, the reference numerals used in FIG. 4 may be reused. It is noted that the method 500 is merely an example and is not intended to limit the present disclosure. Accordingly, it is understood that additional operations may be provided before, during, and after the method 500 of FIG. 5, and that some other operations may only be briefly described herein.

The method 500 starts with operations 502 and 504, in which a number (N) of input data elements (InDE) are received and in which a number (N) of weight data elements (WtDE) are received, respectively, in accordance with some embodiments of the present disclosure. The input data elements InDE and the weight data elements WtDE may each be implemented as a floating point number. The input data elements InDE may correspond to an input word vector, while the weight data elements WtDE may correspond to a weight matrix. Using the circuit 400 depicted in FIG. 4 as an example, the circuit 400 may receive the input data elements InDE and the weight data elements WtDE through the input circuit 404. In some embodiments, the weight data elements WtDE may be stored in storage elements of the memory circuit 402, respectively, and the input data elements InDE can be received through the memory circuit 402 and the input circuit 404.

The method 500 proceeds to operation 506 in which respective signed mantissa portions of the input data elements InDE and the weight data elements WtDE are multiplied with each other to generate products P[1] to P[N], in accordance with some embodiments of the present disclosure. Continuing with the above example of FIG. 4, each of the N input data elements InDE includes a signed mantissa portion, e.g., InS/InM, and each of the N weight data elements WtDE includes a signed mantissa portion, e.g., WtS/WtM. The multiplier circuits 406 can each include a number of logic gates operatively serving as a multiplier (e.g., M1) configured to multiply the signed mantissa portion of a corresponding one of the N input data elements InDE with the signed mantissa portion of a corresponding one of the N weight data elements WtDE, so as to generate a corresponding one of the products P[1] to P[N]. Prior to the multiplication, the multiplier circuits 406 can each reformat or otherwise transform the signed mantissa portions of the corresponding input data element InDE and weight data element WtDE into a two's complement mantissa InTC and a two's complement mantissa WtTC, respectively.

The method 500 proceeds to operation 508 in which respective exponent portions of the input data elements InDE and the weight data elements WtDE are summed together to generate exponent sums S[1]-S[N], in accordance with some embodiments of the present disclosure. Continuing with the above example of FIG. 4, each of the N input data elements InDE includes an exponent portion, e.g., InE, and each of the N weight data elements WtDE includes an exponent portion, e.g., WtE. The multiplier circuits 406 can each include a number of logic gates operatively serving as an adder (e.g., A1) configured to sum the exponent portion of a corresponding one of the N input data elements InDE and the exponent portion of a corresponding one of the N weight data elements WtDE, so as to generate a corresponding one of the exponent sums S[1] to S[N].

The method 500 proceeds to operation 510 in which a maximum exponent sum MaxExp among the exponent sums S[1] to S[N] is identified, in accordance with some embodiments of the present disclosure. Continuing with the above example of FIG. 4, the difference circuit 410 can receive the exponent sums S[1] to S[N], and include a number of logic gates operatively serving as a comparator (e.g., L1) configured to identify the maximum exponent sum MaxExp from the exponent sums S[1] to S[N].

The method 500 proceeds to operation 512 in which exponent differences D[1] to D[N] are generated, in accordance with some embodiments of the present disclosure. Continuing with the above example of FIG. 4, the difference circuit 410 can include a number of logic gates operatively serving as a subtractor (e.g., B1) configured to subtract each of the exponent sums S[1] to S[N] from the maximum exponent sum MaxExp, so as to generate a corresponding one of the exponent differences D[1] to D[N].

The method 500 proceeds to determination operation 514 in which each of the exponent differences D[1] to D[N] is compared with a difference threshold, in accordance with some embodiments of the present disclosure. Continuing with the above example of FIG. 4, the circuit 400 can include a number of logic gates operatively serving as a number of comparators (not shown in FIG. 4), each of which is configured to compare a corresponding one of the exponent differences D[1] to D[N] with the difference threshold and generate a respective control signal. In some embodiments, between each of the exponent differences D[1] to D[N] and the corresponding one of the shifters 413, such a comparator may exist. For example, if any of the exponent differences, e.g., D[n], is identified as being less than or equal to the difference threshold, during a first time period, the comparator can generate a control signal with a first logic state to deactivate a corresponding one of the shifters 413, while concurrently activating the rest of the shifters 413 (operation 516); and, during a second time period, the comparator can generate a control signal with a second, opposite logic state to activate the previously deactivated one of the shifters 413, while concurrently deactivating the rest of the shifters 413 (operation 518).

Upon determining that the exponent differences D[w] to D[x] are each greater than the difference threshold and the exponent differences D[y] to D[z] are each equal to or less than the difference threshold (e.g., by receiving the control signals discussed above), the shifters 413 can block the products P[y] to P[z] from being shifted or being received by the adder tree 414 during the first time period. Concurrently, the shifters 413 can shift the products P[w] to P[x] as shifted products SP[w] to SP[x], respectively (operation 516). Next, in operation 520 (still during the first time period), the shifters 413 can send the shifted products SP[w] to SP[x] to the adder tree 414 to sum the shifted products SP[w] to SP[x] as sum 415_T₁. Next, in operation 524 (still during the first time period), the adder tree 414 can send the sum 415_T₁ to the latch circuit 416 that is (e.g., temporarily) stored therein. The shifters 413 can shift the products P[w] to P[x] using the local maximum exponent sum MaxExpA as a baseline.

Next, during the second time period (e.g., following the first time period), the shifters 413 can block the products P[w] to P[x] from being shifted or being received by the adder tree 414. Instead, the shifters 413 can shift the products P[y] to P[z] as shifted products SP[y] to SP[z], respectively (operation 518). Next, in operation 522 (still during the second time period), the shifters 413 can send the shifted products SP[y] to SP[z] to the adder tree 414 to sum the shifted products SP[y] to SP[z] as sum 415_T₂. During the second time period, the sum 415_T₁ may still be stored in the latch circuit 416. The shifters 413 can shift the products P[y] to P[z] using the local maximum exponent sum MaxExpB as a baseline.

The method 500 proceeds to operation 526 in which the shifted products SP[y] to SP[z] and the shifted products SP[w] to SP[x] are all summed together, in accordance with some embodiments of the present disclosure. Continuing with the above example of FIG. 4, the circuit 400 can include the adder tree 420 to sum the shifted products SP[y] to SP[z] and the shifted products SP[w] to SP[x] as the partial sum PSTC. Alternatively stated, the adder tree 420 can combine the sum 415_T₂ and the sum 415_T₁ as the partial sum PSTC. The adder tree 420 may perform such a combination during a third time period following the second time period. For example, the circuit 400 can first calculate the sum 415_T₁ and temporarily store it at a latch circuit, calculate the sum 415_T₂ while keeping the sum 415_T₁ stored at the latch circuit, and then combine the sum 415_T₁ and sum 415_T₂. In some embodiments of the present disclosure, prior to being combined with the sum 415_T₂ (operation 526), the sum 415_T₁ may first be shifted as shifted sum 415_T₁S using the local maximum exponent sum MaxExpB, which may be equal to MaxExp, as a baseline.

FIGS. 6 and 7 illustrate example schematic diagrams 600 and 700 of a portion of the circuit 400 (FIG. 4), respectively, in accordance with some embodiments of the present disclosure. Specifically, the schematic diagrams 600 and 700 correspond to the same circuit 400 operating during different time periods, e.g., a first time period and a second period. The schematic diagram 600/700 presents an example where sixteen input data elements InDE and sixteen weight data elements WtDE are received or retrieved by the circuit 400. However, the number of input data elements InDE and the number of weight data elements WtDE can be less than or greater than sixteen, while remaining within the scope of the present disclosure.

As shown, the schematic diagram 600/700 includes components 602, 604, 606, 608, 610, 612, and 614. The component 602 may correspond to the logic gates L1 of the difference circuit 410; the component 604 may correspond to the logic gates B1 of the difference circuit 410; the component 606 may correspond to the shifters 413 of the shifting circuit 412; the component 608 may correspond to the adder tree 414; the component 610 may correspond to the latch circuit 416; the component 612 may correspond to the shifting circuit 418; and the component 614 may correspond to the adder tree 420.

In such a configuration, the component 602 can receive exponent sums S[1] to S[16], and output a maximum one of the exponent sums S[1] to S[16] as a maximum exponent sum MaxExp. The component 604 can also receive the exponent sums S[1] to S[16], and generate exponent differences D[1] to D[16] based on subtracting each of the exponent sums S[1] to S[16] from the maximum exponent sum MaxExp. Stated another way, each of the exponent differences D[1] to D[16] is a difference between a corresponding one of the exponent sums S[1] to S[16] and the maximum exponent sum MaxExp. The component 606 includes a plural number of shifters, each of which is configured to receive (e.g., controlled by) a corresponding one of the exponent differences D[1] to D[16]. The shifters of the component 606 are configured to selectively shift the signed mantissa products P[1] to P[16] to the component 608 based on the respective exponent differences D[1] to D[16] during different time periods. In some embodiments, a first subset of the shifters of the component 606 can shift corresponding first ones of the signed mantissa products P[1] to P[16] and output them to the component 608 during a first time period in response to identifying that their corresponding exponent differences being greater than a preset difference threshold, and a second subset of the shifters of the component 606 can shift corresponding second ones of the signed mantissa products P[1] to P[16] and output them to the component 608 during a second time period in response to identifying that their corresponding exponent differences being equal to or less than the preset difference threshold.

For example in FIGS. 6 and 7, in response to identifying that the exponent difference D[15] is equal to or less than a preset difference threshold and other exponent differences are greater than the difference threshold, during a first time period, one of the shifters of the component 606 controlled based on the exponent difference D[15] may be deactivated, while other shifters controlled based on the exponent differences D[1]-D[14] and D[16] may be activated (FIG. 6); and, during a second time period, the shifter of the component 606 controlled based on the exponent difference D[15] may be activated, while other shifters controlled based on the exponent differences D[1]-D[14] and D[16] may be deactivated (FIG. 7). Further, during the first time period (FIG. 6), the signed mantissa products P[1]-P[14] and P[16] are shifted by the activated shifters, respectively, and outputted to the component 608 for summation. The sum outputted by the component 608 during the first time period (415_T₁) is then latched by the latch circuit 610. During the second time period (FIG. 7), the signed mantissa product P[15] is shifted by the activated shifter, and outputted to the component 608 for summation. The sum outputted by the component 608 during the second time period (415_T₂) is then combined with the sum (415_T₁) by the component 614 during a later time period. Continuing with the above example in FIGS. 6-7, prior to being combined with the sum 415_T₂, the component 612 can shift the sum outputted by the component 608 during the first time period (415_T₁). The component 614 can then sum the shifted sum generated during the first time period (415_TIS) and the sum generated during the second time period (415_T₂) as partial sum PSTC.

As discussed above, the circuits 100 and 400 can each include a number of logic gates operatively serving as a number of comparators. Each of these comparators is configured to compare a corresponding one of the exponent differences D[1] to D[N] with a difference threshold and generate a control signal to activate or deactivate a respective shifter. In the example schematic diagram of FIG. 3, each of the first shifters 306A and a corresponding one of the second shifters 306B may receive opposite logic states of a control signal generated by a respective comparator such that the first shifter and the second shifter are alternately activated based on comparing the respective exponent difference with a difference threshold. In the example schematic diagram of FIGS. 6/7, each of the shifters 606 may receive a control signal generated by a respective comparator such that the shifter is selectively activated based on comparing the respective exponent difference with a difference threshold.

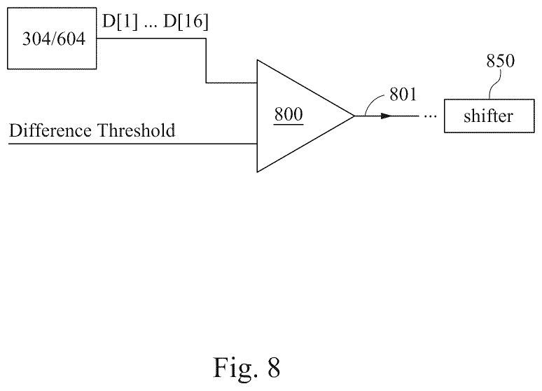

FIG. 8 illustrates an example schematic diagram of such a comparator (hereinafter referred to as “comparator 800”), in accordance with various embodiments of the present disclosure. As shown, the comparator 800 includes two input terminals that are configured to receive one of the exponent differences D[1] to D[N] (from the subtractor 304 or 604), in which N is equal to 16 in the examples, and a difference threshold, respectively. Based on whether the exponent difference is less than, equal to, or greater than the difference threshold, the comparator 800 can output a control signal 801 with a logic state to a corresponding shifter 850, which may be one of the shifters 306A/306B/606.

For example in FIG. 3, when the exponent difference is greater than the difference threshold, the comparator 800 may output the control signal 801 with a first logic state and a second logic state to the corresponding first shifter 306A and the corresponding second shifter 306B, respectively, so as to activate the first shifter 306A and deactivate the second shifter 306B. And, when the exponent difference is equal to or greater than the difference threshold, the comparator 800 may output the control signal 801 with the second logic state and the first logic state to the corresponding first shifter 306A and the corresponding second shifter 306B, respectively, so as to deactivate the first shifter 306A and activate the second shifter 306B. For another example in FIGS. 6/7, when the exponent difference is greater than the difference threshold, the comparator 800 may output the control signal 801 with a first logic state to the corresponding shifter 606, so as to activate the shifter 606 during a first time period. And, during a second time period, the comparator 800 may output the control signal 801 with a second, opposite logic state to the corresponding shifter 606, so as to deactivate the shifter 606.

In one aspect of the present disclosure, a computing-in-memory (CIM) circuit is disclosed. The CIM circuit includes an input circuit configured to receive: (i) a number (N) of first inputs; and (ii) N second inputs, wherein the first inputs consist of N first signs, N first exponents, and N first mantissas, and the second inputs consist of N second signs, N second exponents, and N second mantissas, and wherein each of the second inputs and a corresponding one of the first inputs form one of N input pairs; a first adder circuit configured to combine the first exponent and second exponent of each of the N input pairs, so as to generate N exponent sums; a selector circuit configured to select a largest one among the N exponent sums; a subtractor circuit configured to calculate N exponent differences corresponding to the N input pairs, respectively, each of the N exponent differences being equal to a difference between a corresponding one of the N exponent sums and the largest exponent sum; a multiplier circuit configured to multiply the first mantissas by the second mantissas of the N input pairs, respectively, so as to generate N mantissa products; a second adder circuit configured to combine at least one of: (i) a first subset of the N mantissa products based on the respective exponent differences of the first subset of N mantissa products being greater than a threshold, or (ii) a second subset of the N mantissa products based on the respective exponent differences of the second subset of N mantissa products being equal to or less than the threshold; and a third adder circuit configured to combine all of the N mantissa products.

In another aspect of the present disclosure, a computing-in-memory (CIM) circuit is disclosed. The CIM circuit includes an input circuit configured to receive a number (N) of input pairs, each of the N input pairs comprising a first one and a second one of N exponents, and a first one and a second one of N mantissas; a first adder circuit configured to generate N exponent sums based on the first and second exponents of the N input pairs; a subtractor circuit configured to calculate N exponent differences corresponding to the N input pairs, respectively, each of the N exponent differences being equal to a difference between a corresponding one of the N exponent sums and a largest one of the N exponent sums; and a comparator circuit configured to compare each of the N exponent differences with a threshold to generate N control signals. N mantissa products of the first and second mantissas of the N input pairs, respectively, are to be selectively combined based on the N control signals.

In yet another aspect of the present disclosure, a method for performing multiply-accumulate (MAC) operations is disclosed. The method includes (i) generating a number (N) of exponent sums based on a first exponent and a second exponent of N input pairs, each of the N input pairs further comprising a first mantissa and a second mantissa; (ii) calculating N exponent differences corresponding to the N input pairs, respectively, each of the N exponent differences being equal to a difference between a corresponding one of the N exponent sums and a largest one of the N exponent sums; (iii) generating N control signals by comparing each of the N exponent differences with a threshold; (iv) calculating N mantissa products of the first and second mantissas of the N input pairs, respectively; (v) combining a first subset of the N mantissa products based on a first subset of the N control signals being greater than the threshold; and (vi) combining a second subset of the N mantissa products based on a second subset of the N control signals being equal to or less than the threshold.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., ±10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing-in-memory (CIM) circuit, comprising:
an input circuit configured to receive a first data element and a second data element, the first data element comprising a first exponent and a first mantissa, and the second data element comprising a second exponent and a second mantissa;
a first adder circuit configured to generate a first exponent sum by summing the first exponent and the second exponent;
a subtractor circuit configured to calculate a first exponent difference being equal to a difference between the first exponent sum and a maximum exponent sum;
a comparator circuit configured to compare the first exponent difference with a threshold to generate a first control signal;
a first shifter configured to receive a first mantissa product of the first mantissa and the second mantissa, and shift the first mantissa product in response to the first control signal being equal to a first logic state; and
a second shifter configured to receive the first mantissa product, and shift the first mantissa product in response to the first control signal being equal to a second logic state.

2. The circuit of claim 1, further comprising:
a second adder circuit coupled to the first shifter; and
a third adder circuit coupled to the second shifter.

3. The circuit of claim 2, wherein the second adder circuit is configured to receive the first mantissa product shifted when the first control signal is equal to the first logic state.

4. The circuit of claim 2, wherein the third adder circuit is configured to receive the first mantissa product shifted when the first control signal is equal to the second logic state.

5. The circuit of claim 2, wherein the input circuit is configured to receive a third data element and a fourth data element, the third data element comprising a third exponent and a third mantissa, and the fourth data element comprising a fourth exponent and a fourth mantissa.

6. The circuit of claim 5, wherein the first adder circuit is configured to generate a second exponent sum by summing the third exponent and the fourth exponent.

7. The circuit of claim 6, wherein the subtractor circuit is configured to calculate a second exponent difference being equal to a difference between the second exponent sum and the maximum exponent sum.

8. The circuit of claim 7, wherein the comparator circuit is configured to compare the second exponent difference with the threshold to generate a second control signal.

9. The circuit of claim 8,
wherein the first shifter is configured to receive a second mantissa product of the third mantissa and the fourth mantissa, and shift the second mantissa product in response to the second control signal being equal to the first logic state; and
wherein the second shifter is configured to receive the second mantissa product, and shift the second mantissa product in response to the second control signal being equal to the second logic state.

10. The circuit of claim 9,
wherein the second adder circuit is configured to receive the second mantissa product shifted when the second control signal is equal to the first logic state; and
wherein the third adder circuit is configured to receive the second mantissa product shifted when the second control signal is equal to the second logic state.

11. The circuit of claim 1, wherein the first shifter is activated with the second shifter being concurrently deactivated, when the first control signal is equal to the first logic state.

12. The circuit of claim 1, wherein the second shifter is activated with the first shifter being concurrently deactivated, when the first control signal is equal to the second logic state.

13. A computing-in-memory (CIM) circuit, comprising:
an input circuit configured to receive a first data element and a second data element, the first data element comprising a first exponent and a first mantissa, and the second data element comprising a second exponent and a second mantissa;
a first adder circuit configured to generate a first exponent sum by summing the first exponent and the second exponent;
a subtractor circuit configured to calculate a first exponent difference being equal to a difference between the first exponent sum and a maximum exponent sum;
a comparator circuit configured to compare the first exponent difference with a threshold;
a first shifter configured to receive a first mantissa product of the first mantissa and the second mantissa, and shift the first mantissa product based on the first exponent difference being equal to or less than the threshold; and
a second shifter configured to receive the first mantissa product, and shift the first mantissa product based on the first exponent difference being greater than the threshold.

14. The circuit of claim 13, further comprising:
a second adder circuit coupled to the first shifter; and
a third adder circuit coupled to the second shifter.

15. The circuit of claim 14, wherein the second adder circuit is configured to receive the first mantissa product shifted when the first exponent difference is equal to or less than the threshold.

16. The circuit of claim 14, wherein the third adder circuit is configured to receive the first mantissa product shifted when the first exponent difference is greater than the threshold.

17. The circuit of claim 13,
wherein the input circuit is configured to further receive a third data element and a fourth data element, the third data element comprising a third exponent and a third mantissa, and the fourth data element comprising a fourth exponent and a fourth mantissa;
wherein the first adder circuit is configured to generate a second exponent sum by summing the third exponent and the fourth exponent;
wherein the subtractor circuit is configured to calculate a second exponent difference being equal to a difference between the second exponent sum and the maximum exponent sum;
wherein the comparator circuit is configured to compare the second exponent difference with the threshold;
wherein the first shifter is configured to receive a second mantissa product of the third mantissa and the fourth mantissa, and shift the second mantissa product based on the second exponent difference being equal to or less than the threshold; and
wherein the second shifter is configured to receive the second mantissa product, and shift the second mantissa product based on the second exponent difference being greater than the threshold.

18. The circuit of claim 17,
wherein the second adder circuit is configured to receive the second mantissa product shifted when the second exponent difference is equal to or less than the threshold; and
wherein the third adder circuit is configured to receive the second mantissa product shifted when the second exponent difference is greater than the threshold.

19. A computing-in-memory (CIM) circuit, comprising:
an input circuit configured to receive a first data element and a second data element, the first data element comprising a first exponent and a first mantissa, and the second data element comprising a second exponent and a second mantissa;
a multiplier circuit configured to multiply the first mantissa by the second mantissa to generate a mantissa product;
a first adder circuit configured to generate an exponent sum by summing the first exponent and the second exponent;
a subtractor circuit configured to calculate an exponent difference being equal to a difference between the exponent sum and a maximum exponent sum;
a comparator circuit configured to compare the exponent difference with a threshold;
a first shifter configured to receive the mantissa product, and shift the mantissa product based on the exponent difference being equal to or less than the threshold; and
a second shifter configured to receive the mantissa product, and shift the mantissa product based on the exponent difference being greater than the threshold.

20. The circuit of claim 19, further comprising:
a second adder circuit coupled to the first shifter, and configured to receive the mantissa product shifted when the exponent difference is equal to or less than the threshold; and
a third adder circuit coupled to the second shifter, and configured to receive the mantissa product shifted when the exponent difference is greater than the threshold.
